(19) United States
(12) Patent Application Publication
(10) Pub. No.: US 2017/0220935 A1
(43) Pub. Date: Aug. 3, 2017

(54) MEMBER FEATURE SETS, GROUP FEATURE SETS AND TRAINED COEFFICIENTS FOR RECOMMENDING RELEVANT GROUPS

(71) Applicant: LinkedIn Corporation, Mountain View, CA (US)

(72) Inventors: Sara Smoot Gerrard, Palo Alto, CA (US); Birjodh Tiwana, Lafayette, CA (US); Jessica Zuniga, Mountain View, CA (US); Siva Visakan Sooriyan, San Francisco, CA (US); Félix Joseph Étienne Pageau, San Francisco, CA (US); Prachi Gupta, San Mateo, CA (US); Minal Mehta, Belmont, CA (US)

(21) Appl. No.: 15/009,710

(22) Filed: Jan. 28, 2016

(51) Int. Cl. G06N 5/04; G06N 99/00; H04L 29/08

(52) U.S. Cl. CPC G06N 5/04; H04L 67/306; G06N 99/005

(57) ABSTRACT

A system, a machine-readable storage medium storing instructions, and a computer-implemented method are described herein to a Group Relevance Engine that generates, for a group in a social network, an aggregate group feature based on a common attribute shared amongst member accounts currently subscribed to the group. The Group Relevance Engine identifies an account feature corresponding to the common attribute in a profile of a target member account. The Group Relevance calculates a relevance score based at least on a match between the aggregate group feature and the account feature. The Group Relevance determines whether to recommend the group to the target member account based at least on the relevance score.

### TECHNICAL FIELD

The present disclosure generally relates to data processing systems. More specifically, the present disclosure relates to methods, systems and computer program products for determining relevant content based on trained data and predetermined feature sets.

### BACKGROUND

A social networking service is a computer- or web-based application that enables users to establish links or connections with persons for the purpose of sharing information with one another. Some social networking services aim to enable friends and family to communicate with one another, while others are specifically directed to business users with a goal of enabling the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills, professional organizations, and so on. With some social networking services, a member's profile may be viewable to the public by default, or alternatively, the member may specify that only some portion of the profile is to be public by default. Accordingly, many social networking services serve as a sort of directory of people to be searched and browsed.

### DESCRIPTION OF THE DRAWINGS

Some embodiments are illustrated by way of example and not limitation in the figures of the accompanying drawings in which:

FIG. 1 is a block diagram illustrating a client-server system, in accordance with an example embodiment;

FIG. 2 is a block diagram showing functional components of a professional social network within a networked system, in accordance with an example embodiment;

FIG. 3 is a flowchart illustrating a method of recommending a group to a target member account, according to embodiments described herein.

FIG. 4 is a flowchart illustrating a method of determining an aggregate group feature, according to embodiments described herein.

FIG. 5 is a flowchart illustrating a method of calculating relevance scores, according to embodiments described herein.

FIG. 6 is a block diagram showing a recommendation of a group to a target account member based on a calculated relevance score, according to embodiments described herein.

FIG. 7 is a block diagram showing example components of a Group Relevance Engine according to some embodiments;

FIG. 8 is a block diagram of an example computer system on which methodologies described herein may be executed, in accordance with an example embodiment.

### DETAILED DESCRIPTION

The present disclosure describes methods and systems for predicting a relevance of one or more groups within a professional social networking service (also referred to herein as a “professional social network” and “social network”) to a target member account. In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

A system, a machine-readable storage medium storing instructions, and a computer-implemented method are described herein to a Group Relevance Engine that generates, for a group in a social network, an aggregate group feature based on a common attribute shared amongst member accounts currently subscribed to the group. The Group Relevance Engine identifies an account feature corresponding to the common attribute in a profile of a target member account. The Group Relevance calculates a relevance score based at least on a match between the aggregate group feature and the account feature. The Group Relevance determines whether to recommend the group to the target member account based at least on the relevance score.

In example embodiments, the Group Relevance Engine utilizes a machine learning model for predicting whether a given group in a social network is relevant to a target member account. For example, a group can be a collection of various member accounts of the social network. Other member accounts of the social network can join the group and currently subscribed member accounts can elect to leave the group. A group further includes content, such as articles, comments and discussions that are only accessible to subscribed member accounts.

The Group Relevance Engine builds the model based on training data. The training data includes interactions of member accounts with regard to various groups to which they are subscribed. For example, such interactions comprise social network activity such as posting a comment in the group, “liking” a group, forwarding (i.e. sharing) a group to another member account, creating a group. For purposes of the training data, social network activity can also be a decision by a given member account to not join a group. The training data also includes profile attributes of the various subscribed (and non-subscribed) member accounts who interact with one or more groups and/or are creators of one or more groups. For example, such member account profile attributes include gender, location, industry type, education level, one or more job titles, one or more job descriptions, skills, and endorsements.

The training data is utilized to identify which matched attribute pairs between a given account member and a given group are germane in predicting the relevance of that group to the given account member. Those attributes that are considered germane to predicting relevance are identified as features of the model. The Group Relevance Engine applies logistic regression algorithms to learn coefficient weights for each particular matched attribute pair. In other words, the Group Relevance Engine utilizes logistic regression algorithms to calculate a first learned updateable coefficient weight for an “Education” feature being a match between a given account member's Education attribute and a group's Education attribute. The Group Relevance Engine further utilizes logistic regression algorithms to calculate a second learned updateable coefficient weight for an “Employment” feature being a match between a given account member's Employer attribute and a group's Employer attribute. Each learned coefficient weight reflects a priority weight that the match is given when calculating the relevance score.

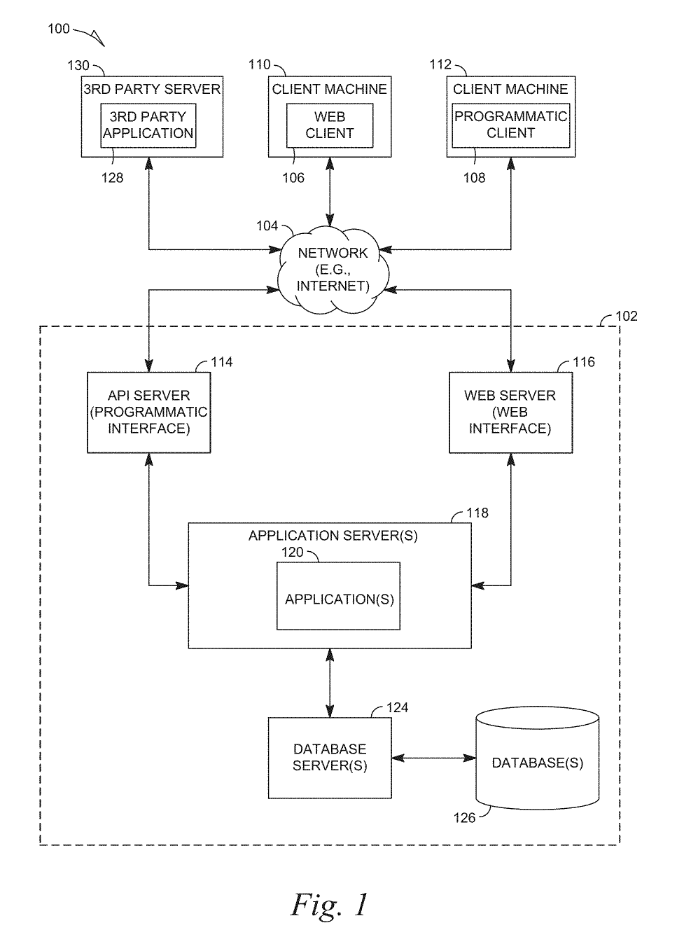

Turning now to FIG. 1, FIG. 1 is a block diagram illustrating a client-server system, in accordance with an example embodiment. A networked system 102. provides server-side functionality via a network 104 (e.g., the Internet or Wide Area. Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 12.4 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102. In some embodiments, the networked system 102 may comprise functional components of a professional social network.

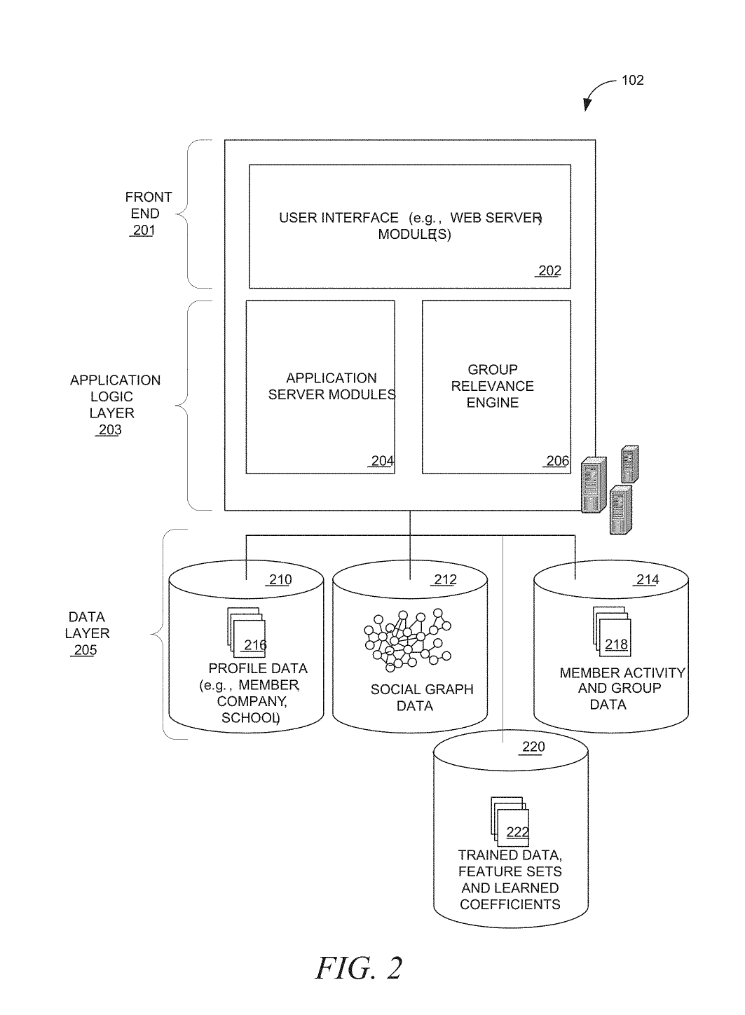

FIG. 2 is a block diagram showing functional components of a professional social network within the networked system 102, in accordance with an example embodiment.

As shown in FIG. 2, the professional social network may be based on a three-tiered architecture, consisting of a front-end layer 201, an application logic layer 203, and a data layer 205. In some embodiments, the modules, systems, and/or engines shown in FIG. 2 represent a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 2. However, one skilled in the art will readily recognize that various additional functional modules and engines may be used with a professional social network, such as that illustrated in FIG. 2, to facilitate additional functionality that is not specifically described herein. Furthermore, the various functional modules and engines depicted in FIG. 2 may reside on a single server computer, or may be distributed across several server computers in various arrangements. Moreover, although a professional social network is depicted in FIG. 2 as a three-tiered architecture, the inventive subject matter is by no means limited to such architecture. It is contemplated that other types of architecture are within the scope of the present disclosure.

As shown in FIG. 2, in some embodiments, the front-end layer 201 comprises a user interface module (e.g., a web server) 202, which receives requests and inputs from various client-computing devices, and communicates appropriate responses to the requesting client devices. For example, the user interface module(s) 202. may receive requests in the form of Hypertext Transport Protocol (HTTP) requests, or other web-based, application programming interface (API) requests.

In some embodiments, the application logic layer 203 includes various application server modules 204, which, in conjunction with the user interface module(s) 202, generates various user interfaces (e.g., web pages) with data retrieved from various data sources in the data layer 205. In some embodiments, individual application server modules 204 are used to implement the functionality associated with various services and features of the professional social network. For instance, the ability of an organization to establish a presence in a social graph of the social network service, including the ability to establish a customized web page on behalf of an organization, and to publish messages or status updates on behalf of an organization, may be services implemented in independent application server modules 204. Similarly, a variety of other applications or services that are made available to members of the social network service may be embodied in their own application server modules 204.

As shown in FIG. 2, the data layer 205 may include several databases, such as a database 210 for storing profile data 216, including both member profile attribute data as well as profile attribute data for various organizations. Consistent with some embodiments, when a person initially registers to become a member of the professional social network, the person will be prompted to provide some profile attribute data such as, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information may be stored, for example, in the database 210. Similarly, when a representative of an organization initially registers the organization with the professional social network the representative may be prompted to provide certain information about the organization. This information may be stored, for example, in the database 210, or another database (not shown). With some embodiments, the profile data 216 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or a seniority level within a particular company. With some embodiments, importing or otherwise accessing data from one or more externally hosted data sources may enhance profile data 216 for both members and organizations. For instance, with companies in particular, financial data may be imported from one or more external data sources, and made part of a company's profile.

The profile data 216 may also include information regarding settings for members of the professional social network. These settings may comprise various categories, including, but not limited to, privacy and communications. Each category may have its own set of settings that a member may control.

Once registered, a member may invite other members, or be invited by other members, to connect via the professional social network. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes allowed to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, may be stored and maintained as social graph data within a social graph database 212.

The professional social network may provide a broad range of other applications and services that allow members the opportunity to share and receive information, often customized to the interests of the member. For example, with some embodiments, the professional social network may include a photo sharing application that allows members to upload and share photos with other members, With some embodiments, members may be able to self-organize into groups, or interest groups, organized around a subject matter or topic of interest. With some embodiments, the professional social network may host various job listings providing details of job openings with various organizations.

As members interact with the various applications, services and content made available via the professional social network, the members' behaviour (e.g., content viewed, links or member-interest buttons selected, etc.) may be monitored and information 218 concerning the member's activities and behaviour may be stored, for example, as indicated in FIG. 2, by the database 214. This information 218 may be used to classify the member as being in various categories and may be further considered as an attribute or feature of the member. For example, if the member performs frequent searches of job listings, thereby exhibiting behaviour indicating that the member is a likely job seeker, this information 218 can be used to classify the member as being a job seeker. This classification can then be used as a member profile attribute for purposes of enabling others to target the member for receiving messages, status updates and/or a list of ranked premium and free job postings. The data layer 205 further includes a machine learning data repository 220 which includes training data, predetermined feature sets and one or more learned updateable coefficients.

In some embodiments, the professional social network provides an application programming interface (API) module via which third-party applications can access various services and data provided by the professional social network. For example, using an API, a third-party application may provide a user interface and logic that enables an authorized representative of an organization to publish messages from a third-party application to a content hosting platform of the professional social network that facilitates presentation of activity or content streams maintained and presented by the professional social network. Such third-party applications may be browser-based applications, or may be operating system-specific. In particular, some third-party applications may reside and execute on one or more mobile devices (e.g., a smartphone, or tablet computing devices) having a mobile operating system.

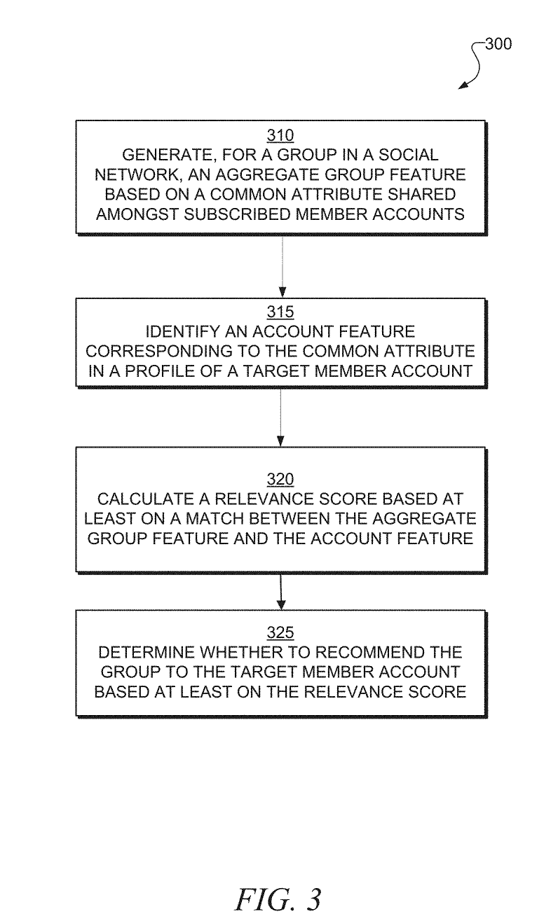

The data in the data layer 205 may be accessed, used, and adjusted by the Group Relevance Engine 206 as will be described in more detail below in conjunction with FIGS. 3-7. Although the Group Relevance Engine 206 is referred to herein as being used in the context of a professional social network, it is contemplated that it may also be employed in the context of any website or online services, including, but not limited to, content sharing sites (e.g., photo- or video-sharing sites) and any other online services that allow users to have a profile and present themselves or content to other users. Additionally, although features of the present disclosure are referred to herein as being used or presented in the context of a web page, it is contemplated that any user interface view (e.g., a user interface on a mobile device or on desktop software) is within the scope of the present disclosure. It is understood that the Group Relevance Engine 206 can be implemented in one or more of the application servers 118.

FIG. 3 is a flowchart illustrating a method 300 of recommending a group to a target member account, according to embodiments described herein.

At operation 310, the Group Relevance Engine 206 generates, for a group in a social network, an aggregate group feature based on a common attribute shared amongst member accounts currently subscribed to the group. A feature set includes any one or more of the following profile attributes: current industry, gender, professional experience, country, geographical region, educational degree, occupational function, employer (current and previous) and skill. The Group Relevance Engine 206 determines a distribution of each of the profile attributes in the feature set across all members subscribed to a group.

For example, a group may have subscriber member accounts that share geographic region attributes. Of the shared geographic region attributes, the top two particular geographic region attributes in the profiles of subscriber member accounts are “West” and “South”. The Group Relevance Engine 206 identifies both “West” and “South” as an aggregate group feature for a geographic region profile attribute.

At operation 315, the Group Relevance Engine 206 identifies an account feature corresponding to the common attribute in a profile of a target member account. The Group Relevance Engine 206 analyses a profile of a target member account in order to determine whether the profile has “West” or “South” as a geographic region profile attribute.

At operation 320, the Group Relevance Engine 206 calculates a relevance score based at least on a match between the aggregate group feature and the account feature. If the target member account has either “West” or “South” as a geographic region profile attribute, then there is a match between the target member account and the group. A relevance score is calculated based at least on the match,

At operation 325, the Group Relevance Engine 206 determines whether to recommend the group to the target member account based at least on the relevance score. The Group Relevance Engine 206 compares the relevance score to a threshold relevance score. If the relevance score meets or exceeds the threshold relevance score, then the Group Relevance Engine 206 generates a notification to be sent to the target member account. For example, the notification can be an email sent to the target member account in the social network. The email includes a selectable link to view the group and a selectable functionality that, when selected, allows the target member account to join the group.

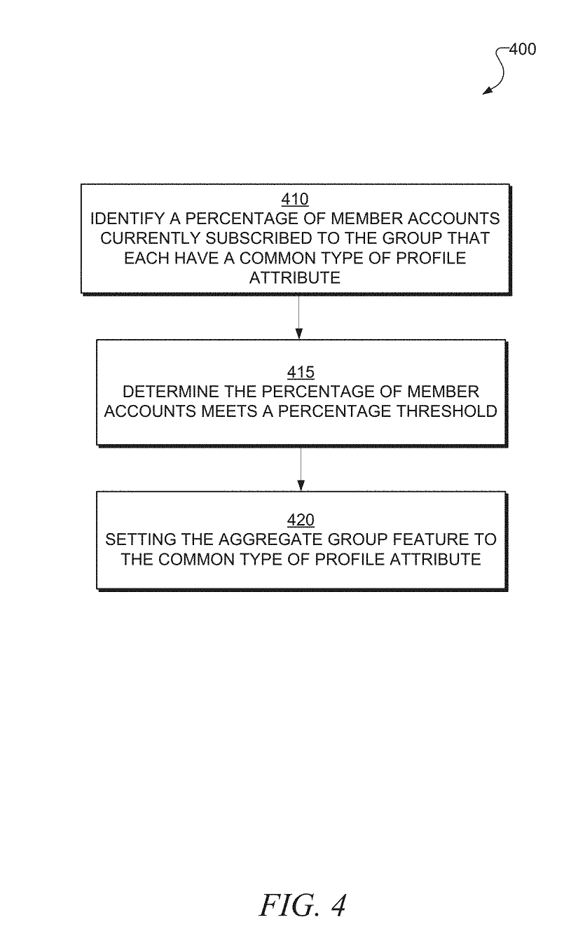

FIG. 4 is a flowchart illustrating a method 400 of determining an aggregate group feature, according to embodiments described herein.

At operation 410, the Group Relevance Engine 206 identifies a percentage of member accounts currently subscribed to the group that each have a common type of profile attribute. For example, a group may have subscriber member accounts that share a certain amount of years of experience in a particular profession.

At operation 420, the Group Relevance Engine 206 determines the percentage of member accounts meets a percentage threshold. Continuing with the example of a group that has subscriber member accounts that share a certain amount of years of experience, the Group Relevance Engine 206 determines the shared professional experience attributes are two particular professional experience attributes (“Senior” and “Mid-Level”) in the profiles of a threshold percentage of subscribed member accounts. For example, a threshold percentage can be 15% or 10% of the subscribed member accounts.

At operation 430, the Group Relevance Engine 206 sets the aggregate group feature to the common type of profile attribute. Continuing with the same example, suppose at least 15% of the member accounts subscribed to the group have either “Senior” or “Mid-Level” as professional experience attributes, then the Group Relevance Engine 206 identifies both “Senior” and “Mid-Level” as an aggregate group feature for a professional experience profile attribute.

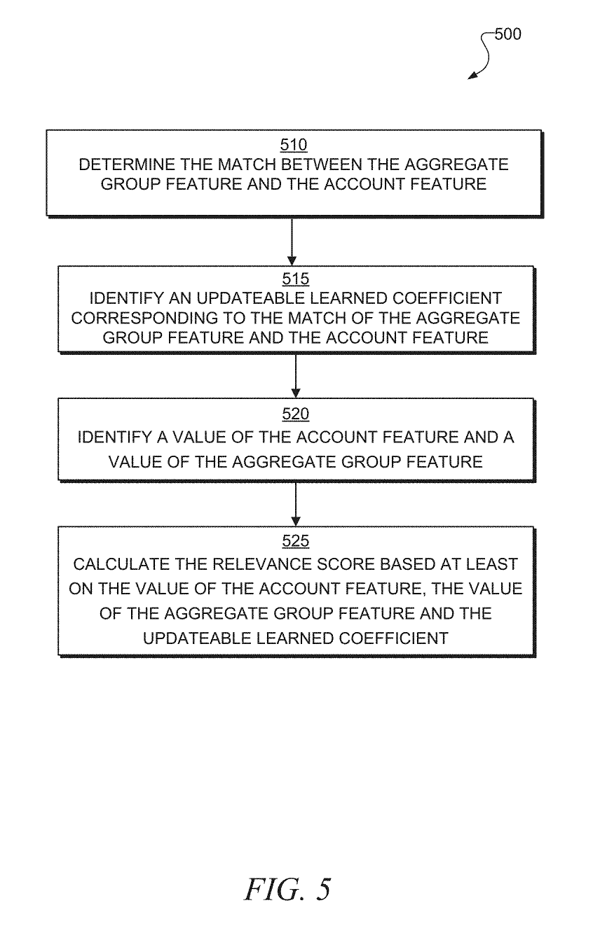

FIG. 5 is a flowchart illustrating a method 500 of calculating relevance scores, according to embodiments described herein.

At operation 510, the Group Relevance Engine 206 determines whether a match between the aggregate group feature and the account feature exists. For example, the Group Relevance Engine 206 determines whether the target member account has “South” or “West” as a geographic region profile attribute. The Group Relevance Engine 206 also determines whether the target member account has “Senior” or “Mid-Level” as a professional experience profile attribute.

At operation 515, the Group Relevance Engine 206 identifies an updateable learned coefficient corresponding to the match of the aggregate group feature and the account feature. Each updateable learned coefficient weight for a match between features of a member account-to-group pair reflects a priority weight that the match is given when calculating the relevance score. For example, if there is a match between the target member account and an aggregate group feature, the Group Relevance Engine 206 will utilize an updateable learned coefficient that corresponds to that type of match.

A match in geographic regions between a profile attribute of a target member account and a first aggregate group feature is associated with a first updateable learned coefficient. A match in professional experience between a profile attribute of a target member account and a second aggregate group feature is associated with a second updateable learned coefficient. It is understood that the first and second updateable learned coefficient can be different than each other.

At operation 525, the Group Relevance Engine 206 calculates the relevance score based at least on the value of the account feature, the value of the aggregate group feature and the updateable learned coefficient. As an example, for a match based on the “South” geographic region attribute, a value of the target member account's geographic region profile attribute is 0.5 (where the target member account has two geographic region attributes) and a value of the aggregate group feature for geographic regions is 0.20 (to reflect that 20% of the member accounts subscribed to the group has the “South” geographic region attribute). The Group Relevance Engine 206 calculates the relevance score for the feature match of the “South” geographic region attribute based at least in part on: a first updateable learned coefficient*[product of 0.5 and 0.20]

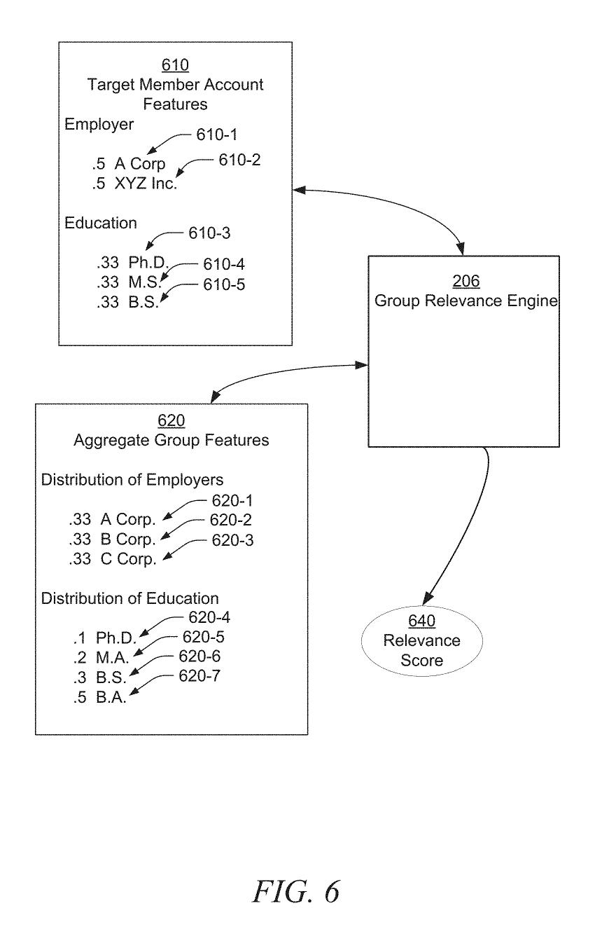

FIG. 6 is a block diagram showing a recommendation of a group to a target account member based on a calculated relevance score, according to embodiments described herein.

Feature sets for accounts and groups are pre-defined in that certain attributes, and therefore matches between attributes, are determined as being germane to predicting whether a group will be relevant to target member account. As illustrated in FIG. 6, the feature set includes an employer attribute and an educational skill attribute. The features 610 of the target member account has two employers 610-1, 610-2 (“A Corp.” and “XYZ Inc.”). The value for both of the particular account's industry features is both 0.5—to reflect that each employer 610-1, 610-2 reflects 50% of the target member account's employer attributes. The target member account has three levels of education (“Ph.D.”, “M.S.” and “B.S.”). The value for each of the target member account's skills features is 0.33—to reflect that each level of education 610-3, 610-4, 610-52 reflects 33% of the target member account's education attributes.

The aggregate group features 620 of a given group has three employers 620-1, 620-2, 620-3 (“A Corp.”, “B Corp” and “C Corp”). The value for each of the aggregate employer features is 0.33—to reflect that each employer attribute appears in 33% of the member accounts currently subscribed to the group. The aggregate group features 620 of the given group has three four levels of education 620-4, 620-5, 620-6, 620-7 (“Ph.D.”, “M.A.”, “B.S.” and “B.A.”). The value for each of the aggregate education level features is 0.1, 0.2, 0.3, 0.5, respectively. The values for the education level features reflect that 10% of subscribed member account have a Ph.D., 20% have an M.A., 33% have a B.S. and 50% have a B.A.

The Group Relevance Engine 206 identifies matches between the target member account features 610 and the aggregate group features 620. For example, the Group Relevance Engine 206 identifies that there are two educational level feature matches for “Ph.D.” 610-3, 620-4 and “B.S.” 610-5, 620-6. The Group Relevance Engine 206 identifies an employer feature match for “A Corp.” 610-1, 620-1.

The Group Relevance Engine 206 calculates the product of the values of the matching features between the target member account and the given group. Each type of feature match has a corresponding learned coefficient (hereinafter “Coeff”). For the “Ph.D.” feature match, the Group Relevance Engine 206 utilizes the dot product of 0.1 and 0.33. The Group Relevance Engine 206 calculates that A=Coeff for “Ph.D.” feature match*[dot product of 0.1 and 0.33].

For the “B.S.” feature match, the Group Relevance Engine 206 utilizes the dot product of 0.3 and 0.33. The Group Relevance Engine 206 calculates that B=Coeff for “B.S.” feature match*[product of 0.3 and 0.33].

For the “A Corp.” feature match, the Group Relevance Engine 206 utilizes the dot product of 0.5 and 0.33. The Group Relevance Engine 206 calculates that C=Coeff for “A Corp.” feature match*[product of 0.5 and 0.33].

The relevance score 640 is based at least in part on A+B+C. If the relevance score 640 at least meets a threshold score, the Group Relevance Engine 206 recommends the given group to the target member account.

In another example embodiment, a feature set can be predefined to consider on employer attributes and education attributes. It is understood that a feature set can include any type of attributes. For an Employer feature, a group has a total number of 10 subscribed member account with an employer profile attribute of “A Corp.” and a total number of 12 subscribed member account with an employer profile attribute of “B Corp” but none in “C Corp.” For an Industry feature, the group has a total number of 8 subscribed member account with an industry profile attribute of “Tech Law” and a total number of 6 subscribed member account with an industry profile attribute of “Healthcare.” Therefore, the Employer feature vector for the group is [10, 12, 0] and the Industry feature vector for the group is [8, 6].

The target member account has two employers, “A Corp.” and “C Corp.” and two industries of “Tech Law” and “Healthcare.” As such, the Employer feature vector for the target member account is [1, 0, 1] and the Industry feature vector for the target member account is [1, 1]. The Group Relevance Engine 206 identifies a first learned coefficient for the Employer feature. The Group Relevance Engine 206 calculates a first dot product of the group's Employer feature vector and the target member account's Employer feature vector. The Group Relevance Engine 206 multiplies the result of the first dot product and the first learned coefficient.

The Group Relevance Engine 206 identifies a second learned coefficient for the Industry feature. The Group Relevance Engine 206 calculates a second dot product of the group's Industry feature vector and the target member account's Industry feature vector. The Group Relevance Engine 206 multiplies the result of the second dot product and the second learned coefficient. The Group Relevance Engine 206 sums the result of the first dot product and the first learned coefficient and the result of the second dot product and the second learned coefficient to obtain a relevance score which predicts how relevant the group is to the target member account. The Group Relevance Engine 206 determines whether the relevance score meets a threshold score. If the relevance score meets or exceeds the threshold score, the Group Relevance Engine 206 sends a notification to the target member account. in one example, the notification can be a message including a recommendation of the group.

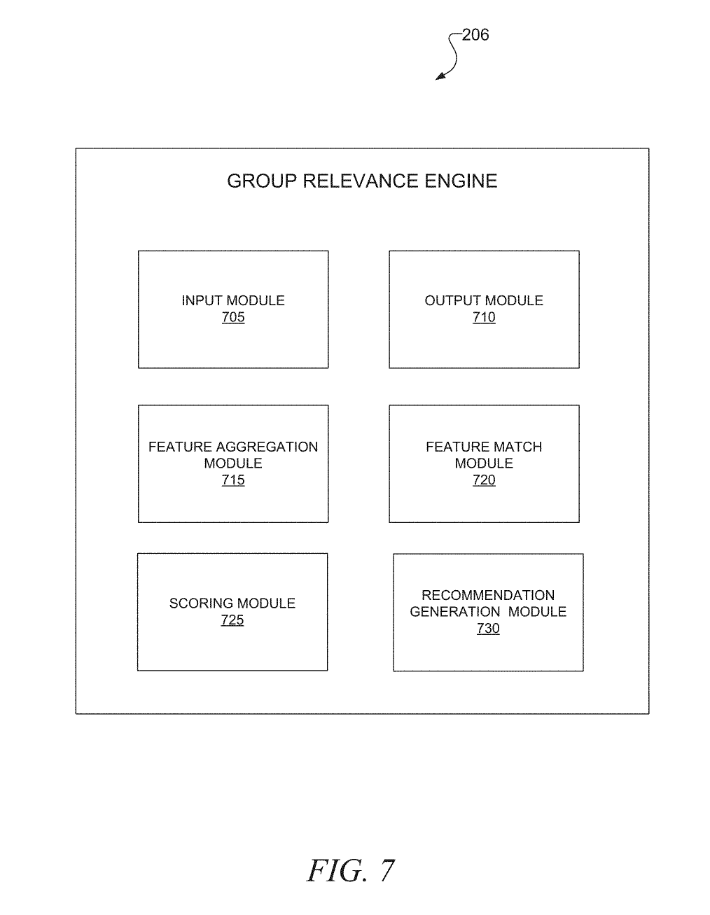

FIG. 7 is a block diagram showing example components of a Group Relevance Engine, according to some embodiments.

The input module 705 is a hardware-implemented module that controls, manages and stores information related to any inputs from one or more components of system 102 as illustrated in FIG. 1 and FIG. 2. In various embodiments, the inputs include one or more member accounts, one or more groups, one or more feature set and one or more learned coefficients as described herein.

The output module 710 is a hardware-implemented module that controls, manages and stores information related to sending a recommendation of one or more groups to a target member account.

The feature aggregation module 715 is a hardware implemented module which manages, controls, stores, and accesses information related to determining aggregate group features as described herein.

The feature match module 720 is a hardware-implemented module which manages, controls, stores, and accesses information related to identifying one or more matching feature pairs between a target member account and one or more groups as described herein.

The scoring module 725 is a hardware-implemented module which manages, controls, stores, and accesses information related to calculating one or more relevance scores as described herein.

The recommendation generation module 730 is a hardware-implemented module which manages, controls, stores, and accesses information related to generating a recommendation of one or more groups for a target member account as described herein.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

in various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. in embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method. may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

in example embodiments, operations may be performed by one or more programmable processors executing a computer program to perform functions by operating on input data and generating output, Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

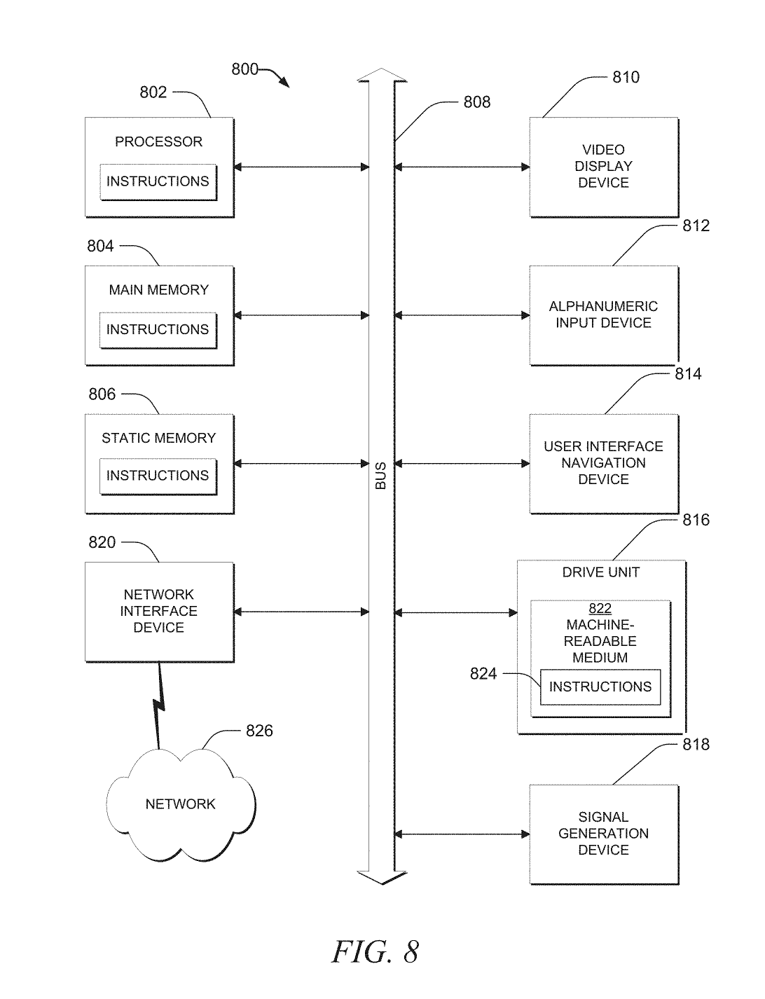

FIG. 8 is a block diagram of a machine in the example form of a computer system 800 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 800 includes a processor 802 (e.g., a. central processing unit (CPU), a graphics processing unit (GPU) or both), a main memory 804, and a static memory 806, which communicate with each other via a bus 808. Computer system 800 may further include a video display device 810 (e.g., a liquid crystal display (LCD) or a cathode ray tube (CRT)). Computer system 800 also includes an alphanumeric input device 812 (e.g., a keyboard), a user interface (UI) navigation device 814 (e.g., a mouse or touch sensitive display), a disk drive unit 816, a signal generation device 818 (e.g., a speaker) and a network interface device 820.

Disk drive unit 816 includes a machine-readable medium 822 on which is stored one or more sets of instructions and data structures (e.g., software) 824 embodying or utilized by any one or more of the methodologies or functions described herein. Instructions 824 may also reside, completely or at least partially, within main memory 804, within static memory 806, and/or within processor 802 during execution thereof by computer system 800, main memory 804 and processor 802 also constituting machine-readable media.

While machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 824 may further be transmitted or received over a communications network 826 using a transmission medium. Instructions 824 may be transmitted using network interface device 820 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer system comprising:
a processor;
a memory device holding an instruction set executable on the processor to cause the computer system to perform operations comprising:
generating, for a group in a social network, an aggregate group feature based on a common attribute shared amongst member accounts currently subscribed to the group;
identifying an account feature corresponding to the common attribute in a profile of a target member account;
calculating a relevance score based at least on a match between the aggregate group feature and the account feature; and
determining whether to recommend the group to the target member account based at least on the relevance score.

2. The computer system of claim 1, wherein generating, for a group in a social network, an aggregate group feature based on a common attribute shared amongst member accounts currently subscribed to the group comprises:
identifying a percentage of member accounts currently subscribed to the group that each have a common type of profile attribute;
determining the percentage of member accounts meets a percentage threshold; and
setting the aggregate group feature to the common type of profile attribute.

3. The computer system of claim 2, wherein the common type of profile attribute comprises at least one of: current industry, gender, professional experience, country, geographical region, educational degree, occupational function, employer and skill.

4. The computer system of claim 1, wherein calculating a relevance score based at least on a match between the aggregate group feature and the account feature comprises:
determining the match between the aggregate group feature and the account feature;
identifying an updateable learned coefficient corresponding to the match of the aggregate group feature and the account feature; and
identifying a value of the account feature;
identifying a value of the aggregate group feature; and
calculating the relevance score based at least on the value of the account feature, the value of the aggregate group feature and the updateable learned coefficient.

5. The computer system of claim 4, wherein the updateable learned coefficient represents a learned weighting of importance of the match in calculating the relevance score.

6. The computer system of claim 4, wherein the value of the aggregate group feature is based on a percentage of member accounts currently subscribed to the group that each have a type of profile attribute used as the aggregate group feature.

7. The computer system of claim 4, wherein determining the match between the aggregate group feature and the account feature comprises:
determining the match based on a cosine similarity between the aggregate group feature and the account feature.

8. A computer-implemented method comprising:
generating, for a group in a social network, an aggregate group feature based on a common attribute shared amongst member accounts currently subscribed to the group;
identifying an account feature corresponding to the common attribute in a profile of a target member account;
calculating, using one or more processors, a relevance score based at least on a match between the aggregate group feature and the account feature; and
determining whether to recommend the group to the target member account based at least on the relevance score.

9. The computer-implemented method of claim 8, wherein generating, for a group in a social network, an aggregate group feature based on a common attribute shared amongst member accounts currently subscribed to the group comprises:
identifying a percentage of member accounts currently subscribed to the group that each have a common type of profile attribute;
determining the percentage of member accounts meets a percentage threshold; and
setting the aggregate group feature to the common type of profile attribute.

10. The computer-implemented method of claim 9, wherein the common type of profile attribute comprises at least one of: current industry, gender, professional experience, country, geographical region, educational degree, occupational function, employer and skill.

11. The computer-implemented method of claim 8, wherein calculating a relevance score based at least on a match between the aggregate group feature and the account feature comprises:
determining the match between the aggregate group feature and the account feature;
identifying an updateable learned coefficient corresponding to the match of the aggregate group feature and the account feature; and
identifying a value of the account feature;
identifying a value of the aggregate group feature; and
calculating the relevance score based at least on the value of the account feature, the value of the aggregate group feature and the updateable learned coefficient.

12. The computer-implemented method of claim 11, wherein the updateable learned coefficient represents a learned weighting of importance of the match in calculating the relevance score.

13. The computer-implemented method of claim 11, wherein the value of the aggregate group feature is based on a percentage of member accounts currently subscribed to the group that each have a type of profile attribute used as the aggregate group feature.

14. A non-transitory computer-readable medium storing executable instructions thereon, which, when executed by a processor, cause the processor to perform operations including:
generating, for a group in a social network, an aggregate group feature based on a common attribute shared amongst member accounts currently subscribed to the group;
identifying an account feature corresponding to the common attribute in a profile of a target member account;
calculating a relevance score based at least on a match between the aggregate group feature and the account feature; and
determining whether to recommend the group to the target member account based at least on the relevance score.

15. The non-transitory computer-readable medium of claim 14, wherein generating, for a group in a social network, an aggregate group feature based on a common attribute shared amongst member accounts currently subscribed to the group comprises:
identifying a percentage of member accounts currently subscribed to the group that each have a common type of profile attribute;
determining the percentage of member accounts meets a percentage threshold; and
setting the aggregate group feature to the common type of profile attribute.

16. The non-transitory computer-readable medium of claim 15, wherein the common type of profile attribute comprises at least one of: current industry, gender, professional experience, country, geographical region, educational degree, occupational function, employer and skill.

17. The non-transitory computer-readable medium of claim 14, wherein calculating a relevance score based at least on a match between the aggregate group feature and the account feature comprises:
determining the match between the aggregate group feature and the account feature;
identifying an updateable learned coefficient corresponding to the match of the aggregate group feature and the account feature; and
identifying a value of the account feature;
identifying a value of the aggregate group feature; and
calculating the relevance score based at least on the value of the account feature, the value of the aggregate group feature and the updateable learned coefficient.

18. The non-transitory computer-readable medium of claim 17, wherein the updateable learned coefficient represents a learned weighting of importance of the match in calculating the relevance score.

19. The non-transitory computer-readable medium of claim 17, wherein the value of the aggregate group feature is based on a percentage of member accounts currently subscribed to the group that each have a type of profile attribute used as the aggregate group feature.

20. The non-transitory computer-readable medium of claim 17, wherein determining the match between the aggregate group feature and the account feature comprises:
determining the match based on a cosine similarity between the aggregate group feature and the account feature.
